(19) United States
(12) Patent Application Publication
(10) Pub. No.: US 2026/0119367 A1
(43) Pub. Date: Apr. 30, 2026

(54) SOFTWARE USE SITUATION INVESTIGATION SYSTEM, SOFTWARE USE SITUATION INVESTIGATION APPARATUS, AND SOFTWARE USE SITUATION INVESTIGATION METHOD

(71) Applicant: Hitachi Vantara, Ltd., Yokohama-shi (JP)

(72) Inventors: Yuki KOKAI, Yokohama-shi (JP); Tomohiro KAWAGUCHI, Yokohama-shi (JP)

(21) Appl. No.: 19/302,188

(22) Filed: Aug. 18, 2025

(30) Foreign Application Priority Data
Oct. 25, 2024 (JP) 2024-188128

(51) Int. Cl. G06F 11/34; G06F 9/54

(52) U.S. Cl. CPC G06F 11/3476; G06F 9/547

(57) ABSTRACT

A software use situation investigation system includes a storage system that provides an API, a client server into which software is introduced, and a software use situation investigation apparatus. The client server includes identification information on the software in an API request and transmits the API request to the storage system. A management processing unit of the storage system records an API log that is a log related to API access to the API by the software such that the identification information on the software is included in the API log, and stores the API log in a log holding unit. The software use situation investigation apparatus acquires the API log from the storage system and creates information indicating a use situation of the software based on the API log.

### CROSS-REFERENCE TO RELATED APPLICATION

The present application claims priority from Japanese application JP2024-188128, filed on Oct. 25, 2024, the content of which is hereby incorporated by reference into this application.

### BACKGROUND OF THE INVENTION

### 1. Field of the Invention

The present invention relates to a software use situation investigation system, a software use situation investigation apparatus, and a software use situation investigation method.

### 2. Description of Related Art

Storage vendors provide software, such as management software and plug-ins used for a storage product (storage system) in a bundle or free of charge with the storage product. However, the storage vendors have not established a system for managing and tracking the use situation and the function use rate of each piece of software.

Therefore, it is not possible to distinguish between software functions that are in high and low demand among customers, and it is not possible to allocate appropriate investments in software functions based on data (use situation) according to customer demands. As a result, the extension and development of a function having a high customer value for software have not been performed. From the user's perspective, the additional development of functions that are used frequently is not given priority, and functions that are not used by users are developed, which may result in a lack of usability of the software and the functions thereof and a decrease in user satisfaction. Therefore, there is a demand for grasping the use situation of each piece of software from the storage vendors and the users. Such problems and demands are also present in systems other than the storage system (software used in other systems).

PTL 1 (JP2001-306314A) discloses a software management method for recording a use record of software. This software management method grasps the use frequency of software as follows.

A software supply apparatus includes a server and a user database. When a user terminal downloads a software program from the software supply apparatus, the software supply apparatus assigns user terminal identification information to the software program and registers the user terminal identification information and identification information on an access point used by the user terminal to connect to a communication network in the user database.

The server collates the user terminal identification information notified when the user terminal executes the software and the access point used at the time of the notification with a content of the user database, and when the user terminal identification information is in the user database and the used access point matches access point identification information on the user database, the server transmits use permission information on software to the user terminal and updates the information on a use record of the user database. Since the software vendor can accurately grasp the use frequency of software from the user database, it can be used as reference information for subsequent software development.

PTL 2 (JP2021-174129A) discloses an application programming interface (API) charging system in which a history of requests from an application to an API for a system platform and a history of responses from the system platform to the application are recorded by an API connection platform, and an API use fee for use of the API by the application is calculated based on the histories.

PTL 3 (JP2019-96060A) discloses an API charging system in which an API management device stores histories of requests and responses to one API for each of a plurality of applications using the one API, and a charging management device determines a charging value of an application using the one API based on a charging condition when using the one API and information on the histories acquired from the API management device.

### CITATION LIST

### Patent Literature

PTL 1: JP2001-306314A

PTL 2: JP2021-174129A

PTL 3: JP2019-96060A

### SUMMARY OF THE INVENTION

The inventor of the present application has studied a new software use situation investigation apparatus for grasping the use situation of each piece of software used for a system (for example, a storage system).

A user of a system to which the REST API is applied uses software on a terminal connected to the system via a network. In this case, software (a Rest API client) accesses the system via a network, internally calls an application programming interface (API) on the system side, and operates the system using the API, thereby executing each function implemented in each piece of software.

The REST API performs session-based user authentication. When the Rest API client accesses a Rest API server and starts an operation on the system, the Rest API client first calls a session generation API on the system side and performs user authentication using information (a user ID and a password) on the user for accessing the system.

However, since an individual identifier (identification information) is not assigned to the Rest API client (software), the system cannot determine the Rest API client (software) that is an API caller. Therefore, although it can be seen that the user is performing some operation using the API (Rest API server) on the system side, the number of API calls of each piece of software and the use of each function cannot be aggregated, and thus the use situation of each piece of software cannot be grasped. It is possible to aggregate the use situation of software by collecting logs on the device side of the user executing the software. However, in this case, since the logs are managed by software and the logs are not centralized, it takes time to collect the logs, resulting in a complicated configuration and procedure.

The software management method of PTL 1 requires management of the user terminal identification information and the access point identification information and processing using these pieces of information, resulting in a complicated configuration and procedure. PTL 2 and PTL 3 do not disclose that, as in the invention, an API access to an API on a system side of software to which identification information is assigned is performed by acquiring, from the system, an API audit log in which the identification information on the API-accessed software is recorded to remain, and information indicating a use situation of the software is generated from the API audit log.

An object of the invention is to provide a software use situation investigation system, a software use situation investigation apparatus, and a software use situation investigation method capable of grasping a use situation of each piece of software used for a system without requiring a complicated configuration and procedure.

To solve the above problems, the software use situation investigation system according to the invention is a software use situation investigation system including: a plurality of systems each configured to provide an API and each including an arithmetic device and a first storage device; a plurality of client servers into which software that accesses the API via a network and executes a function is introduced, the client servers each configured to transmit an API request to the system and receive an API response from the system by an operation of the software; and a software use situation investigation apparatus including an information processing apparatus, in which the client server includes identification information on the software in the API request and transmits the API request to the system, the arithmetic device of the system records an API log that is a log related to API access to the API by the software such that the identification information on the software is included in the API log, and stores the API log in the first storage device, and the information processing apparatus acquires the API log from the system and creates information indicating a use situation of the software based on the API log.

The software use situation investigation apparatus according to the invention is a software use situation investigation apparatus including: an information processing apparatus configured to investigate a use situation of software that accesses an API provided by a system via a network and executes a function of the software, in which the information processing apparatus is configured to acquire, from the system, an API log that is a log related to API access to the API by the software to which identification information is assigned and is recorded to include the identification information on the software, and create information indicating the use situation of the software based on the API log.

The software use situation investigation method according to the invention is a software use situation investigation method using an information processing apparatus configured to investigate a use situation of software that accesses an API provided by a system via a network and executes a function of the software, and the software use situation investigation method includes: acquiring, from the system, an API log that is a log related to API access to the API by the software to which identification information is assigned and is recorded to include the identification information on the software, and creating information indicating the use situation of the software based on the API log by the information processing apparatus.

According to the invention, it is possible to grasp the use situation of each piece of software used for the system without requiring a complicated configuration and procedure. The effects described herein are not necessarily limited, and may be any effects described in the present disclosure.

### BRIEF DESCRIPTION OF THE DRAWINGS

FIG. 1A is a diagram illustrating a configuration example of a software use situation investigation system according to a first embodiment;

FIG. 1B is a diagram illustrating a configuration example of a system including a customer system platform and a second cloud platform;

FIG. 2 is a block diagram illustrating an example of a hardware block configuration of a storage system;

FIG. 3 is a schematic configuration diagram illustrating a configuration example of an information processing apparatus applied to a client server and a cloud server;

FIG. 4A is a diagram illustrating a format of an API log;

FIG. 4B is a diagram illustrating an example of the API log recorded for a plurality of API accesses;

FIG. 5A is a diagram illustrating a tool ID management table;

FIG. 5B is a diagram illustrating a serial ID model correspondence table;

FIG. 5C is a diagram illustrating a serial ID customer correspondence table;

FIG. 6 is a diagram illustrating a log conversion table;

FIG. 7 is a diagram illustrating a use aggregation table;

FIG. 8A is a diagram illustrating a use statistical table;

FIG. 8B is a diagram illustrating a model use statistical table;

FIG. 8C is a diagram illustrating a customer use statistical table;

FIG. 9 is a diagram illustrating operations of a system;

FIG. 10 is a diagram illustrating operations of the system;

FIG. 11 is a diagram illustrating a technique in the related art;

FIG. 12 is a sequence diagram illustrating an operation of each element of the system;

FIG. 13 is a sequence diagram illustrating an operation of each element of the system;

FIG. 14 is a flowchart illustrating a processing flow executed by an log interpretation unit and a use information extraction unit;

FIG. 15 is a diagram illustrating an example of a screen created by a use rate display unit;

FIG. 16 is a diagram illustrating an example of the screen created by the use rate display unit;

FIG. 17 is a diagram illustrating an example of the screen created by the use rate display unit;

FIG. 18 is a diagram illustrating an example of the screen created by the use rate display unit;

FIG. 19 is a diagram illustrating an example of the screen created by the use rate display unit;

FIG. 20 is a diagram illustrating a processing flow executed by the use rate display unit;

FIG. 21 is a diagram illustrating a processing flow executed by the use rate display unit;

FIG. 22 is a diagram illustrating a processing flow executed by the use rate display unit;

FIG. 23 is a diagram illustrating a processing flow executed by the use rate display unit;

FIG. 24 is a diagram illustrating a processing flow executed by the use rate display unit;

FIG. 25 is a diagram illustrating an API management table;

FIG. 26 is a diagram illustrating an example of a log conversion table held (stored) by the software use situation investigation system;

FIG. 27 is a diagram illustrating an API use aggregation table;

FIG. 28 is a diagram illustrating an API use statistical table;

FIG. 29 is a flowchart illustrating a processing flow executed by the log interpretation unit and the use information extraction unit;

FIG. 30 is a diagram illustrating an example of the screen created by the use rate display unit;

FIG. 31 is a diagram illustrating an example of the screen created by the use rate display unit;

FIG. 32 is a diagram illustrating a modification of the invention;

FIG. 33 is a flowchart illustrating a processing flow executed by an API calling unit of the modification of the invention;

FIG. 34 is a diagram illustrating a per-model use number screen; and

FIG. 35 is a diagram illustrating a customer use number screen.

### DESCRIPTION OF EMBODIMENTS

Hereinafter, embodiments of the invention will be described with reference to the drawings. In the drawings of the embodiments, the same or corresponding parts may be denoted by the same reference numerals.

In the following description, various types of information may be described using expressions such as “table,” “record,” “row,” “column,” and “line,” but the various types of information may be expressed using data structures other than these. When describing identification information, expressions such as “ID” and “name” are used, but these expressions can be replaced with each other and can be replaced with expressions of other identification information.

In the following description, although processing may be described using a functional block as a subject, the subject of the processing may be a CPU or an apparatus instead of the functional block. The subject of the processing executed by executing a program may be an arithmetic unit and may include a dedicated circuit that executes specific processing. Here, the dedicated circuit is, for example, a field programmable gate array (FPGA), an application specific integrated circuit (ASIC), or a complex programmable logic device (CPLD).

### First Embodiment

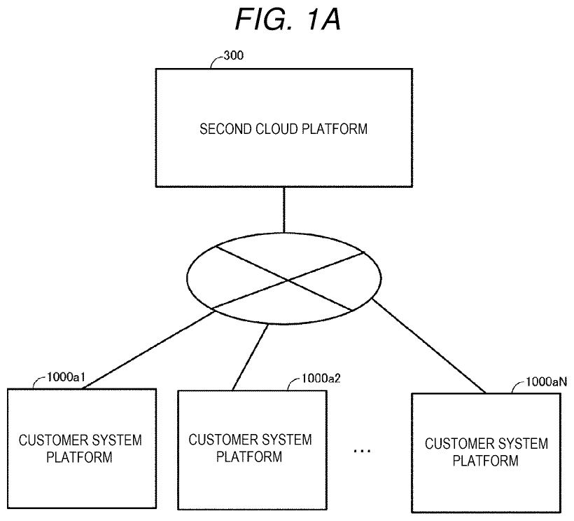

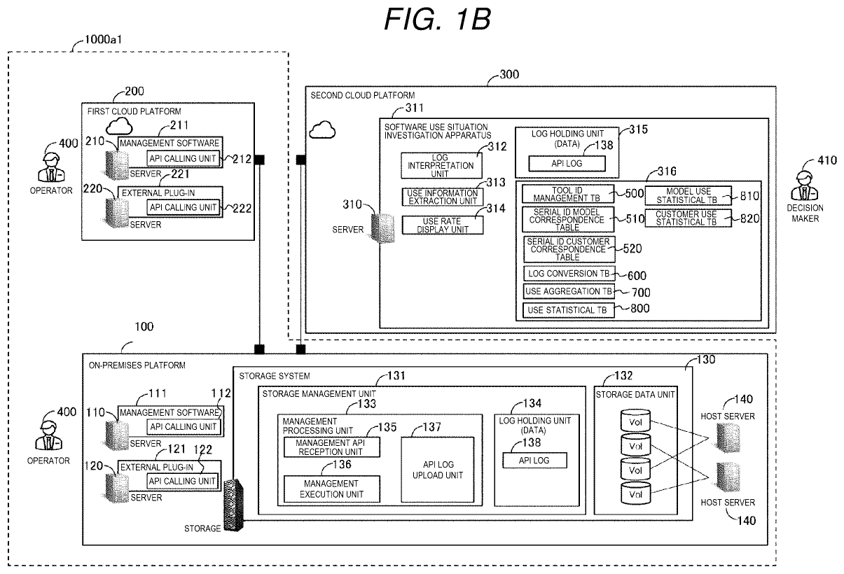

A software use situation investigation system according to a first embodiment of the invention will be described. FIG. 1A is a diagram illustrating a configuration example of the software use situation investigation system according to the first embodiment. As illustrated in FIG. 1A, the software use situation investigation system includes a plurality of customer system platforms 1000a1 to 1000aN and a second cloud platform 300. These are connected via a network to be able to transmit and receive information (data) to and from each other. Hereinafter, the plurality of customer system platforms 1000a1 to 1000aN may be referred to as “customer system platforms 1000a” when there is no need to particularly distinguish them. The plurality of customer system platforms 1000a may be the customer system platforms 1000a of different customers, or two or more of them may be the customer system platforms 1000a of the same customer. In the present example, the customer system platform 1000a is a system platform including a storage system. The customer system platform 1000a includes a storage system that provides an API, a host server, and a client server into which software is introduced and which transmits an API request to the storage system and receives an API response from the storage system by operations of the software. As an example of the configuration of the customer system platform 1000a, details of the customer system platform 1000a1 are illustrated in FIG. 1B to be described later, but the configuration of the customer system platform 1000a is not limited thereto.

FIG. 1B is a diagram illustrating a configuration example of a system including the customer system platform 1000a1 and the second cloud platform 300. As illustrated in FIG. 1B, the system includes the customer system platform 1000a1 and the second cloud platform 300. The customer system platform 1000a1 includes an on-premises platform 100 and a first cloud platform 200. These are connected via a network to be able to transmit and receive information (data) to and from each other. In the present example, the customer system platforms 1000a2 to 1000aN have the same configuration as the customer system platform 1000a1 (however, models of a storage system 130 may be the same or different).

The on-premises platform 100 includes a computer system constructed in an on-premises environment. The computer system includes a first management server 110, a second management server 120, the storage system 130, and a host server 140.

The first management server 110 manages the storage system 130. Management software 111 is introduced (installed) in the first management server 110. The first management server 110 executes the management software 111. The management software 111 includes an API calling unit 112. The API calling unit 112 has a request construction function, an authentication management function, an error handling function, and a response processing function. In the present example, the name of the management software 111 is “Management Software A”, and the Tool ID is “mms345g7jf56”.

The request construction function constructs a request for performing operations such as acquisition, storage, update, and deletion of data for the storage system 130. The request construction function constructs a request by combining an end point, an HTTP method, a parameter, and the like. The request construction function constructs a request to further include a Tool ID assigned to the management software 111 in the request. For example, the request construction function includes an argument for inputting the Tool ID in a header or a body of the API request, includes an argument for inputting the Tool ID in a body (for example, a JSON file) of the request, and includes the Tool ID in the request by passing a specific Tool ID as an argument.

The authentication management function manages authentication information such as an API key and a token, and applies the authentication information to a request. The error handling function performs error message processing and retry processing when an API call fails. The response processing function analyzes a response from the API and extracts necessary data.

For example, when the API calling unit 112 acquires data from the storage system 130, the API calling unit 112 constructs a request for data acquisition by using the request construction function and the authentication management function. The request includes an end point for data acquisition, an HTTP method (GET), a necessary header (the authentication information or the like), a parameter (a query parameter), and a Tool ID. The API calling unit 112 transmits the constructed request to a management API reception unit 135 of the storage system 130. Upon receiving a response from the management API reception unit 135, the API calling unit 112 analyzes the response with the response processing function and extracts necessary data.

An external plug-in 121 is introduced (installed) into the second management server 120. The second management server 120 executes the external plug-in 121 of the storage system 130. The external plug-in 121 is software for extending the functions of the storage system 130. The external plug-in 121 includes an API calling unit 122 having the same function as the management software 111. In the present example, the name of the external plug-in 121 is “Plug-In A”, and the Tool ID is “jjuh786s39ik”. The storage system 130 includes a storage management unit 131 and a storage data unit 132. The storage management unit 131 includes a management processing unit 133 and a log holding unit 134. The management processing unit 133 includes the management API reception unit 135, a management execution unit 136, and an API log upload unit 137.

The management processing unit 133 provides an interface for the storage system 130 to communicate with clients (the first management server 110, the second management server 120, a first cloud server 210, and a second cloud server 220). The management processing unit 133 enables the clients to perform operations such as acquisition, storage, update, and deletion of data via the API.

The management API reception unit 135 publishes an API end point for accessing a specific function or resource provided by the API to allow the clients to operate data. The management API reception unit 135 receives requests from the clients, performs appropriate processing according to the requests by the management execution unit 136, and then returns responses to the clients. For example, in response to a data acquisition request, designated data is returned.

The management execution unit 136 performs appropriate processing according to the request. The management execution unit 136 performs access control related to API use. The management execution unit 136 authenticates clients and confirms access restrictions to resources. The management execution unit 136 converts a format of request data or response data from or to the clients as necessary (for example, converts data in the JSON format into data in the XML format). The management execution unit 136 records an API log 138, which is a log related to API access, in the log holding unit 134.

The API log upload unit 137 uploads the API log 138 to the log holding unit 315 of the second cloud platform 300.

The log holding unit 134 holds (stores) the API log 138.

The storage data unit 132 includes volumes. The volumes are provided to the host server 140.

The host server 140 is a computer (a server device) that issues an IO request. The host server 140 may be a physical computer or a virtual computer. The host server 140 is connected to the storage data unit 132 via a storage area network (SAN). The host server 140 is provided with the volumes from the storage data unit 132. The host server 140 recognizes the volumes by mounting the volumes on a host.

The first cloud platform 200 is a cloud capable of providing a resource-providing service on the first cloud platform 200. The first cloud platform 200 includes the first cloud server 210 and the second cloud server 220 provided by the resource providing service. The first management server 110 and the second management server 120 described above, and the first cloud server 210 and the second cloud server 220 are referred to as “client servers” when there is no need to particularly distinguish them.

The first cloud server 210 manages the storage system 130. Management software 211 is introduced (installed) into the first cloud server 210. The first cloud server 210 executes the management software 211. The management software 211 includes an API calling unit 212. The API calling unit 212 has the same function as the API calling unit 112 described above. In the present example, the name of the management software 211 is “Management Software B”, and the Tool ID is “s88fwasgggg”.

The external plug-in 221 is introduced (installed) into the second cloud server 220. The second cloud server 220 executes the external plug-in 221 of the storage system 130. The external plug-in 221 is software for extending the functions of the storage system 130. The external plug-in 221 includes an API calling unit 222 having the same function as the management software 111. In the present example, the name of the external plug-in 221 is “Plug-In B”, and the Tool ID is “s88fwajdasua”. The second cloud platform 300 is a cloud capable of providing a resource-providing service on the second cloud platform 300, and includes a cloud server 310 provided by the resource-providing service.

The cloud server 310 may be referred to as a “software use situation investigation apparatus”. The cloud server 310 includes a log interpretation unit 312, a use information extraction unit 313, a use rate display unit 314, the log holding unit 315, and a database 316. The log interpretation unit 312 acquires the API log 138 from the log holding unit 134 and creates a log conversion table 600. The use information extraction unit 313 creates a use aggregation table 700 and a use statistical table 800 based on the log conversion table 600. The use information extraction unit 313 further creates a model use statistical table 810 and a customer use statistical table 820. The use rate display unit 314 creates a display screen (an image) based on the use statistical table 800 and the like, and displays the display screen on a display.

The log holding unit 315 includes the API log 138. The API log 138 is uploaded from the API log upload unit 137 and held (stored) in the log holding unit 134.

The database 316 includes a tool ID management table 500, a serial ID model correspondence table 510, a serial ID customer correspondence table 520, the log conversion table 600, the use aggregation table 700, the use statistical table 800, the model use statistical table 810, and the customer use statistical table 820. Details of these tables will be described later.

### Hardware Configuration

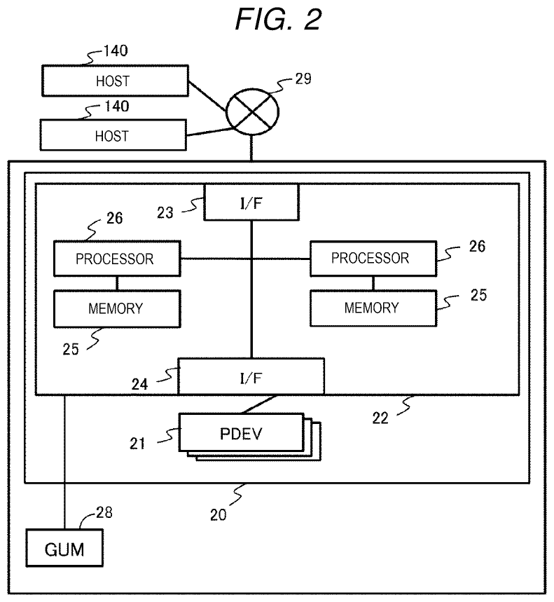

FIG. 2 is a block diagram illustrating an example of a hardware configuration of the storage system 130. The storage system 130 includes a plurality of (or one) PDEVs 21, which are physical storage devices, and a storage controller 22 connected to the PDEVs 21.

The storage controller 22 includes an I/F 23, an I/F 24, two memories 25, and two processors 26 connected thereto.

The I/F 23 is a communication interface device that mediates data exchange between an external device (for example, the host server 140) and the storage controller 22. The host server 140 is connected to the I/F 23 via a fibre channel (FC) network 29.

The host server 140 transmits, to the storage controller 22, an I/O request (a write request or a read request) designating an I/O destination (for example, a logical volume number such as a logical unit number (LUN) or a logical address such as a logical block address (LBA)).

The I/F 24 is a communication interface device that mediates data exchange between the plurality of PDEVs 21 and the storage controller 22. The plurality of PDEVs 21 are connected to the I/F 24.

The memory 25 stores programs executed by the processor 26 and data used by the processor 26. The processor 26 executes the programs stored in the memory 25. In the present example, a set of the memory 25 and the processor 26 is duplicated.

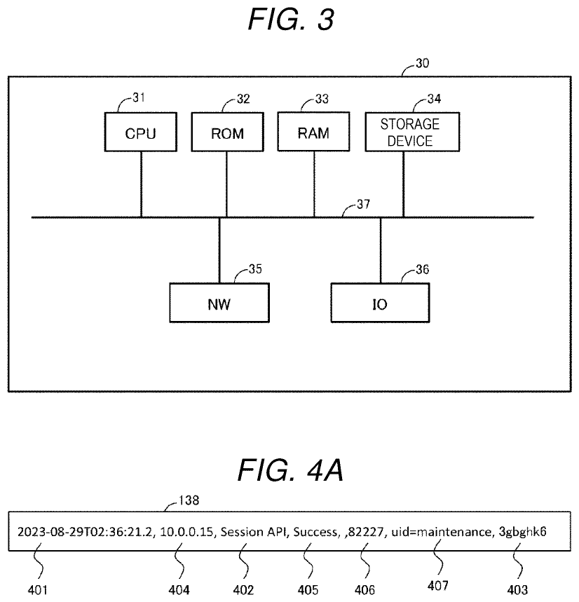

A gateway for unified management (GUM) 28 is a computer having a basic management function for the storage system 130. When the storage system 130 is managed from the outside, communication with the GUM 28 is performed. The computer includes a CPU, a ROM, a RAM, a non-volatile storage device capable of reading and writing data, a network interface, and an input and output interface (that is, the computer has the same configuration as an information processing apparatus illustrated in FIG. 3 to be described later). The management processing unit 133 is implemented by a program stored in the ROM and/or the storage device. The log holding unit 134 is implemented by a storage device.

FIG. 3 is a schematic configuration diagram illustrating a configuration example of an information processing apparatus applied to the client servers and the cloud server 310. As illustrated in FIG. 3, an information processing apparatus 30 includes a CPU 31, a ROM 32, a RAM 33, a non-volatile storage device 34 capable of reading and writing data, a network interface 35, and an input and output interface 36. The information processing apparatus 30 applied to a server on the cloud is a virtual information processing apparatus constructed on the cloud.

The ROM 32 and/or the storage device 34 hold (store) software and various programs. The software and the various programs include programs for implementing various functions of the information processing apparatus 30.

The CPU 31 loads a program stored in the ROM 32 and/or the storage device 34 into the RAM 33. The CPU 31 implements various functions of the information processing apparatus 30 by executing the program loaded on the RAM 33.

The program executed by the CPU 31 is loaded on the RAM 33 as described above, and data used when the CPU 31 executes the program is temporarily stored in the RAM 33.

The network interface 35 is an interface for connecting the information processing apparatus 30 to a network. The input and output interface 36 is an interface for connecting operation devices such as a keyboard and a mouse, a display, and the like.

At least a part of the processing executed by the CPU 31 executing the program may be executed by another arithmetic device (for example, hardware such as an ASIC or an FPGA).

In the cloud server 310, the log interpretation unit 312, the use information extraction unit 313, and the use rate display unit 314 are implemented by the programs stored in the ROM 32 and/or the storage device 34. The log holding unit 315 is implemented by the storage device 34. The database 316 is stored in the storage device 34.

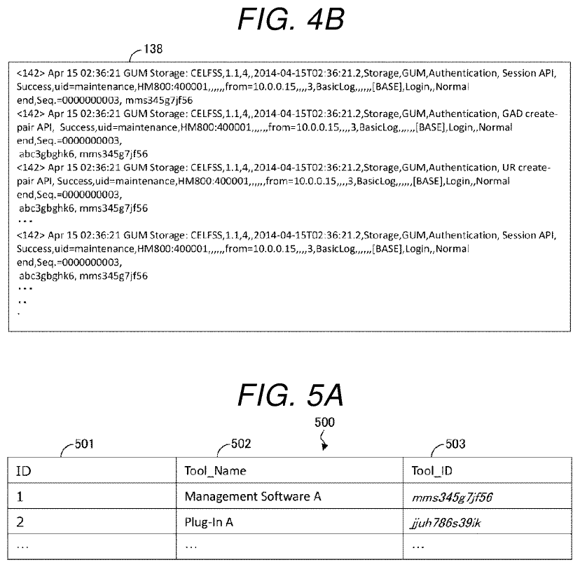

FIG. 4A is a diagram illustrating a format of the API log 138. The API log 138 is a log related to API access of the software (for example, an operation log, an audit log, an API access log, or the like), and is recorded for each API request. FIG. 4A illustrates the API log 138 for one API request. The API log 138 includes at least a date and time 401 when the API is called, a type of the called API (API type 402), and a Tool ID 403 of the caller. The API log 138 may include, as optional items, an IP address 404 of an operation source (the caller), an operation result 405 (Success or Fail), a Serial ID 406, and authentication information 403.

FIG. 4B illustrates an example of the API log 138 recorded for a plurality of API accesses. For example, the API log 138 is stored in a file format. The API log 138 is created and stored such that the Serial ID of the storage system 130 is included in the file name.

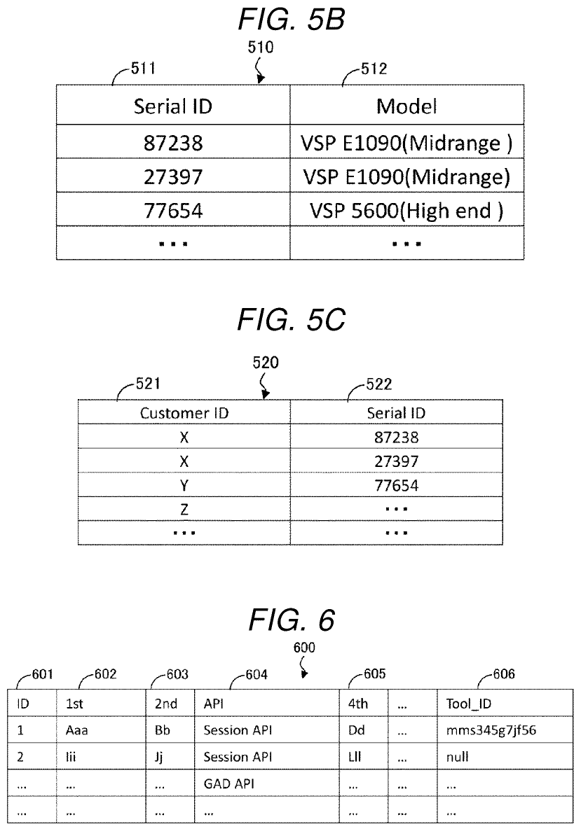

FIG. 5A is a diagram illustrating the tool ID management table 500. The tool ID management table 500 includes an ID 501, a Tool Name 502, and a Tool ID 503 as lines (columns) for storing information (values). In the tool ID management table 500, pieces of information corresponding to respective lines for managing software whose use situation is to be investigated are associated with each other and stored as information (records) in units of rows.

Specifically, the ID 501 stores identification information (ID) for identifying the corresponding record. The Tool Name 502 stores the name of the software. The Tool ID 503 stores a Tool ID, which is identification information on the software.

FIG. 5B is a diagram illustrating the serial ID model correspondence table 510. The serial ID model correspondence table 510 includes a Serial ID 511 and a Model 512 as lines (columns) for storing information (values). In the serial ID model correspondence table 510, information corresponding to each line for managing the Serial ID and a storage model is associated with each other and stored as information (record) in units of rows.

Specifically, the Serial ID 511 stores identification information (Serial ID) of the storage system 130. The Model 512 stores a name of a model of the storage system 130.

FIG. 5C is a diagram illustrating the serial ID customer correspondence table 520. The serial ID customer correspondence table 520 includes a Customer ID 521 and a Serial ID 522 as lines (columns) for storing information (values). In the serial ID customer correspondence table 520, information corresponding to each line for managing the storage system 130 used by the customer is associated with each other and stored as information (record) in units of rows.

Specifically, the Customer ID 521 stores identification information (Customer ID) for identifying a customer. The Serial ID 522 stores identification information (Serial ID) of the storage system 130.

FIG. 6 is a diagram illustrating the log conversion table 600. The log conversion table 600 includes an ID 601, 1st 602, 2nd 603, an API 604, 4th 605, and a Tool ID 606 as lines (columns) for storing information (values). Although a plurality of lines (columns) similar to 1st 602, 2nd 603, and 4th 605 are included between 4th 605 and the Tool ID 606, the illustration thereof is omitted.

In the log conversion table 600, information corresponding to each line related to a character string in units obtained by dividing the text of the API log 138 by a delimiter is stored in association with each other as information (records) in units of rows.

Specifically, the ID 601 stores identification information (ID) for identifying the corresponding record. Each of 1st 602, 2nd 603, 4th 605, and a plurality of lines (columns) (not illustrated) stores a character string in units divided by a delimiter. The API 604 stores a character string indicating a type of the API (API name). The Tool ID 606 stores a Tool ID that is identification information on the software. Although details will be described later, the log conversion table 600 is created from the API log 138 by the log interpretation unit 312. One record is information in which a plurality of character strings obtained by dividing the text of the API log 138 written by one API request with delimiters are stored in lines (columns).

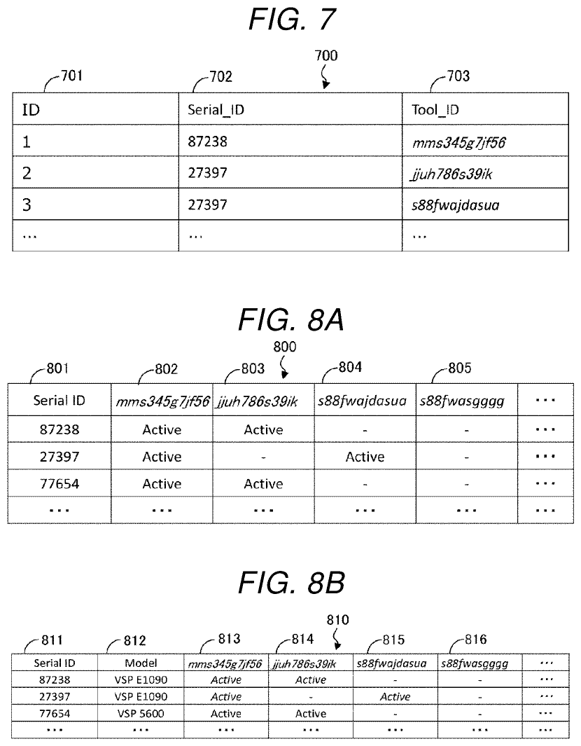

FIG. 7 is a diagram illustrating the use aggregation table 700. The use aggregation table 700 includes an ID 701, a Serial ID 702, and a Tool ID 703 as lines (columns) for storing information (values).

In the use aggregation table 700, information corresponding to each line related to statistical information on the use situation of software is stored as information (records) in units of rows in association with each other. Specifically, the ID 701 stores identification information (ID) for identifying the corresponding record. The Serial ID 702 stores identification information (a Serial ID) of the storage system 130. The Tool ID 703 stores a Tool ID, which is identification information on software. Although details will be described later, the use aggregation table 700 is created by the use information extraction unit 313 based on the log conversion table 600.

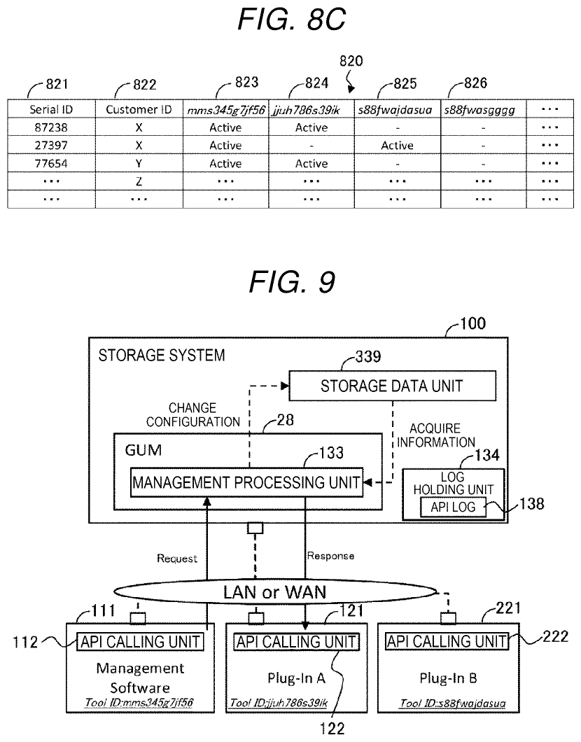

FIG. 8A is a diagram illustrating the use statistical table 800. The use statistical table 800 includes a Serial ID 801, mms345g7jf56 802, jjuh786s39ik 803, s88fwajdasua 804, and s88fwasgggg 805 as lines (columns) for storing information (values). In the use statistical table 800, information corresponding to each line related to statistical information on the use situation of software is stored as information (records) in units of rows in association with each other.

Specifically, the Serial ID 801 stores identification information (Serial ID) of the storage system 130. The mms345g7jf56 802 stores information indicating whether the software of a Tool ID “mms345g7jf56” is used for the corresponding storage system 130. “Active” indicates that the software of the corresponding Tool ID is used for the storage system indicated by the corresponding Serial ID. “−” indicates that the software of the corresponding Tool ID is not used for the storage system indicated by the corresponding Serial ID.

The jjuh786s39ik 803 stores information indicating whether the software of the Tool ID “jjuh786s39ik” is used for the corresponding storage system 130. The s88fwajdasua 804 stores information indicating whether the software of the Tool ID “s88fwajdasua” is used for the corresponding storage system 130. The s88fwasgggg 805 stores information indicating whether the software of the Tool ID “s88fwasgggg” is used for the corresponding storage system 130. The use statistical table 800 is created by the use information extraction unit 313 based on the use aggregation table 700.

FIG. 8B is a diagram illustrating the model use statistical table 810. The model use statistical table 810 includes a Serial ID 811, a Model 812, mms345g7jf56 813, jjuh786s39ik 814, s88fwajdasua 815, and s88fwasgggg 816 as lines (columns) for storing information (values). In the model use statistical table 810, information corresponding to each line related to statistical information on the use situation of software is stored as information (records) in units of rows in association with each other.

Specifically, the Serial ID 811 stores identification information (Serial ID) of the storage system 130. The Model 812 stores the name of the storage model. The mms345g7jf56 813 stores information indicating whether the software of the Tool ID “mms345g7jf56” is used for the corresponding storage system 130. The jjuh786s39ik 814 stores information indicating whether the software of the Tool ID “jjuh786s39ik” is used for the corresponding storage system 130. The s88fwajdasua 815 stores information indicating whether the software of the Tool ID “s88fwajdasua” is used for the corresponding storage system 130. The s88fwasgggg 816 stores information indicating whether the software of the Tool ID “s88fwasgggg” is used for the corresponding storage system 130.

FIG. 8C is a diagram illustrating the customer use statistical table 820. The customer use statistical table 820 includes a Serial ID 821, a Customer ID 822, mms345g7jf56 823, jjuh786s39ik 824, s88fwajdasua 825, and s88fwasgggg 826 as lines (columns) for storing information (values).

Specifically, the Serial ID 821 stores identification information (Serial ID) of the storage system 130. The Customer ID 822 stores identification information (Customer ID) for identifying a customer. The mms345g7jf56 823 stores information indicating whether the software of the Tool ID “mms345g7jf56” is used for the corresponding storage system 130. The jjuh786s39ik 824 stores information indicating whether the software of the Tool ID “jjuh786s39ik” is used for the corresponding storage system 130. The s88fwajdasua 825 stores information indicating whether the software of the Tool ID “s88fwajdasua” is used for the corresponding storage system 130. The s88fwasgggg 826 stores information indicating whether the software of the Tool ID “s88fwasgggg” is used for the corresponding storage system 130.

### Operations

An operation when the software of each client server calls an API in the system will be described. Each function implemented in each piece of software is implemented by internally calling the API on the storage system 130 side.

In the present example, a REST API may be applied to the API provided by the storage system 130. In this case, the storage system 130 provides a Web API according to the principle of representational state transfer (REST) to acquire information and change the configuration of the storage system 130. In this case, the management processing unit 133 corresponds to a Rest API Server, and each of the API calling unit 112, the API calling unit 122, and the API calling unit 213 corresponds to an API Client.

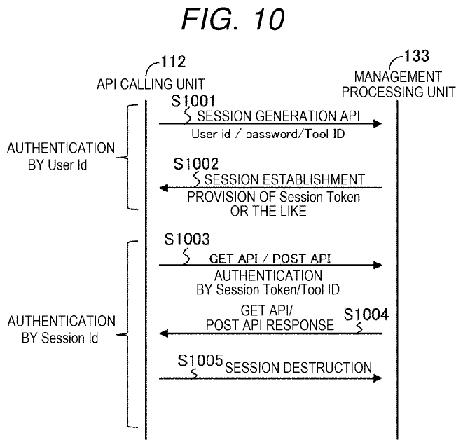

An operation example when software uses an API will be described with reference to FIGS. 9 and 10. The management processing unit 133 is disposed on the GUM 28 of the storage system 130. The management processing unit 133 receives a request from the API calling unit 112 of the management software 111, issues the request to the storage system 130, and responds an execution result to the API calling unit 112.

The management processing unit 133 receives a request from the API calling unit 122 of the external plug-in 121, issues the request to the storage system 130, and responds an execution result to the API calling unit 122.

The management processing unit 133 receives a request from the API calling unit 222 of the external plug-in 221, issues the request to the storage system 130, and responds an execution result to the API calling unit 212.

In the following description, the operation of the API calling unit 112 of the management software 111 will be described as an example, and the operation of the API calling unit 122 of the external plug-in 121 and the operation of the API calling unit 222 of the external plug-in 221 are the same as the operation of the API calling unit 112 of the management software 111, and thus the description thereof will be omitted.

When the API calling unit 112 executes an operation on the storage system 130, user authentication is required. This system performs session-based user authentication. When the API calling unit 112 accesses the management processing unit 133 and starts an operation, the system always generates a session first. The session is generated by executing an API for session generation in response to a request for the session generation API from the API calling unit 112. The request for the session generation API includes a user ID, a password, a Tool ID, and the like. As described above, the Tool ID is an ID of software (in this case, software that issues the request for the session generation API).

In the request for the session generation API, authentication using the user ID and the password for accessing the storage system 130 is performed (S1001 in FIG. 10). When the session is generated (established), a Session ID and a Session token are provided to the API calling unit 112 as a response (S1002 in FIG. 10).

To execute the API after the session is generated (established), the API calling unit 112 specifies the Session Token in an Authorization header of the request and transmits the request to the management processing unit 133 (S1003 in FIG. 10). This request also includes the Tool ID. The management processing unit 133 performs authentication based on session information (Session Token). The management processing unit 133 determines whether the request is issued from the authenticated user (API calling unit 112)) based on the authentication information (Session Token), and returns a response to the API calling unit 112 (S1004 in FIG. 10). When the operation from the API calling unit 112 is ended, the session is destroyed (deleted) from the management processing unit 133 (S1005 in FIG. 10). When the session is not used and a predetermined time elapses, the session is automatically destroyed.

The management processing unit 133 writes and stores the API log 138 in the log holding unit 134 for each API call.

### Comparison With Related Art

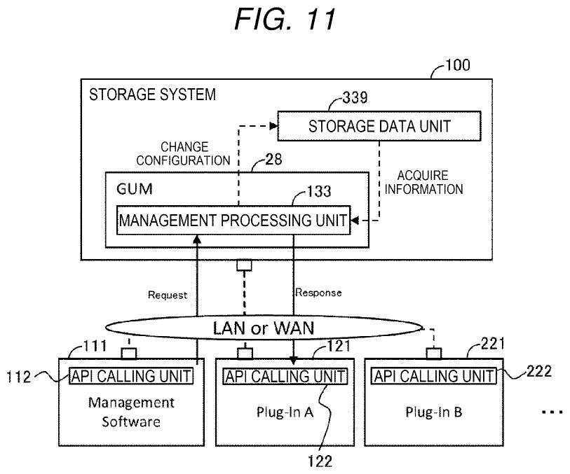

Here, a comparison between an operation when software in the related art calls an API and the invention will be described. In the related art, similarly to the invention, a user ID common to each piece of software is used in user authentication (processing corresponding to S1001 in FIG. 10) at the time of initial session generation. However, in the related art, as illustrated in FIG. 11, since the API caller does not have an individual identifier (Tool ID), the API caller cannot be determined. Therefore, it can be seen that the software corresponding to the user ID is performing some operation by using the management processing unit 133 on the storage system 130 side, but since it is not known which software is calling the API, the number of API calls for each piece of software and the use number of each function for each piece of software cannot be aggregated on the storage system 130 side. In the related art, the number of API calls for each piece of software and the use number of each function (API) for each piece of software may be aggregated by collecting logs on the software side, but the configuration and procedure are considerably complicated.

Therefore, in the invention, the Tool ID is assigned to each piece of software, the external software assigns (embeds) the Tool ID to the API request when calling the API provided by the storage system 130, and the storage system 130 (the management processing unit 133) that has received the API request writes the Tool ID to the API log 138. Accordingly, the Tool ID is extracted from the API log 138 based on the Tool ID described in the log, and the information for analyzing the use situation of each piece of software in the storage system 130 can be aggregated on the storage system 130 side without requiring a complicated configuration and procedure.

### Overall System Operation

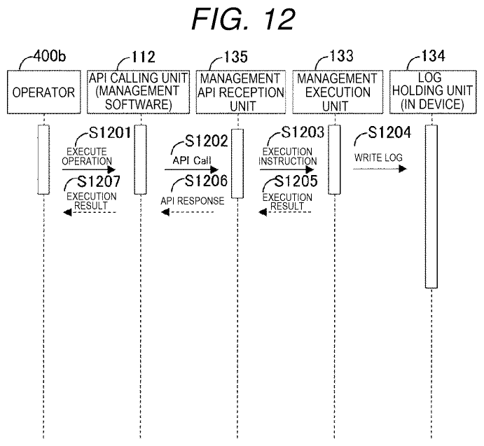

FIG. 12 is a sequence diagram illustrating an operation of each element of the system.

S1201: An operator 400 performs a specific operation on the client server.

S1202: The API calling unit 112 (the management software 111) generates an API request according to a specific operation. As described above, the API request includes the Tool ID. The API calling unit 112 (the management software 111) transmits the API request to the management API reception unit 135 of the storage system 130.

S1203: The management API reception unit 135 issues a request (execution instruction) to the management execution unit 136 of the storage system 130.

S1204: The management execution unit 136 writes the API log 138 to the log holding unit 134. As described above, at this time, the API log 138 is written in the log holding unit 134 to include the Tool ID.

S1205: The management execution unit 136 transmits an execution result for the request (execution instruction) to the management API reception unit 135.

S1206: The management API reception unit 135 transmits the execution result to the API calling unit 112 as a response.

S1207: The API calling unit 112 provides the execution result for the specific operation to the client server (operator 400) using the response.

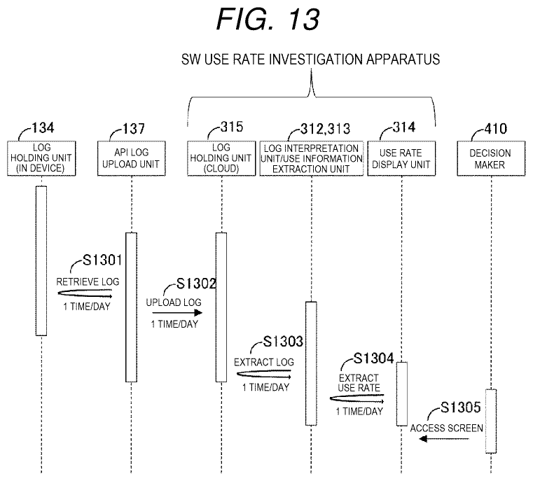

By the above operations, the management execution unit 136 writes the API log 138 in the log holding unit 134 for each API call. The log holding unit 134 holds (stores) the API log 138. FIG. 13 is a sequence diagram illustrating an operation of each element of the system.

S1301: The API log upload unit 137 retrieves the API log 138 held (stored) in the log holding unit 134 periodically (in the present example, once per day (once at a predetermined time)). Accordingly, the log for each day is loaded into the API log upload unit 137 in a file format.

S1302: The API log upload unit 137 uploads the API log 138 in a file format to the log holding unit 315 of the second cloud platform 300. The log holding unit 315 holds (stores) the API log 138 in a file format.

S1303: The log interpretation unit 312 and the use information extraction unit 313 acquire the API log 138 from the log holding unit 315, and create the use aggregation table 700 and the use statistical table 800 from the API log 138. Details of this processing will be described later. Then, the use information extraction unit 313 creates the model use statistical table 810 from the use statistical table 800 and the serial ID model correspondence table 510. The use information extraction unit 313 creates the customer use statistical table 820 from the use statistical table 800 and the serial ID customer correspondence table 520.

S1304: The use rate display unit 314 calculates (extracts) information (for example, a use rate) necessary for screen display from the use statistical table 800.

S1305: A decision maker 410 can grasp the use situation of the software (such as the number of storage systems 130 using the software) by viewing a screen provided by the use rate display unit 314.

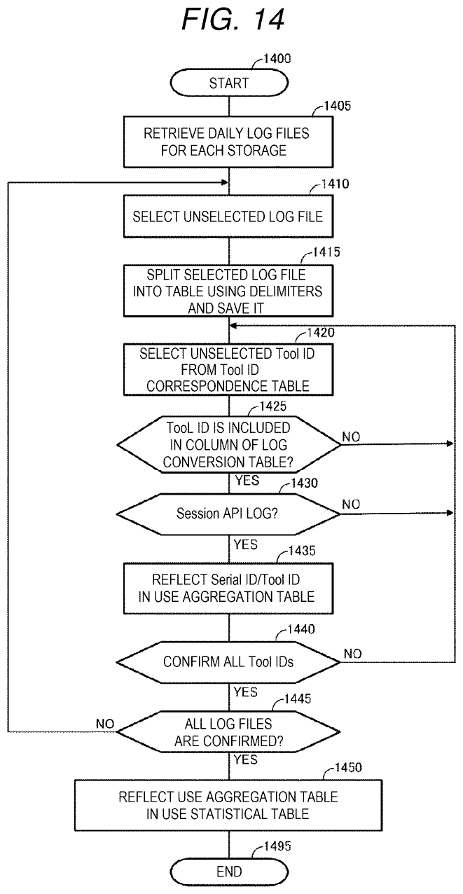

FIG. 14 is a flowchart illustrating a processing flow executed by the log interpretation unit 312 and the use information extraction unit 313.

The log interpretation unit 312 starts processing from step 1400 at a predetermined time, and executes processing of step 1405 to step 1415 to be described later.

Step 1405: The log interpretation unit 312 retrieves log files (the API log 138) in units of days for each storage for a plurality of storages to be investigated.

Step 1410: The log interpretation unit 312 selects an unselected log file (one of the API logs 138 of the plurality of storage systems).

Step 1415: The log interpretation unit 312 converts the selected log file (API log 138) into the log conversion table 600 by dividing the selected log file by delimiters, assigns [LogDB_serial id], (the Serial Id of the storage system 130 is substituted in serial id), which includes the serial ID of the storage system 130 corresponding to the selected log file in the name of the log conversion table 600, as a name of the log conversion table, and saves (manages) the log conversion table. For example, when the Serial Id of the storage system 130 is “87238”, the name of the log conversion table 600 is “LogDB 87238”.

Next, in step 1420, the use information extraction unit 313 selects one unselected Tool ID from the tool ID management table 500 (Tool ID correspondence table), and the processing proceeds to step 1425.

In step 1425, the use information extraction unit 313 determines whether at least one Tool ID selected in step 1420 is included in the column (Tool ID 604) of the log conversion table 600.

If no Tool ID selected in step 1420 is included in the column (Tool ID 604) of the log conversion table 600, the use information extraction unit 313 determines “NO” in step 1425, returns to step 1420, and selects one unselected Tool ID from the tool ID management table 500 (Tool ID correspondence table), and the processing proceeds to step 1425.

If at least one Tool ID selected in step 1420 is included in the column (Tool ID 604) of the log conversion table, the use information extraction unit 313 determines “YES” in step 1425, and the processing proceeds to step 1430.

In step 1430, the use information extraction unit 313 determines whether the log (record) corresponding to the Tool ID is a log of the Session API by confirming whether the type of the API corresponding to the Tool ID is a Session API. When a plurality of Tool IDs are included in the column (Tool ID 604) of the log conversion table, this determination is performed for each of the plurality of logs (records) corresponding to Tool IDs.

If all of the logs (records) corresponding to Tool IDs are not logs of Session API, the use information extraction unit 313 determines “NO” in step 1430, returns to step 1420, and selects one unselected Tool ID from the tool ID management table 500 (Tool ID correspondence table), and the processing proceeds to step 1425.

If at least one log (record) corresponding to the Tool ID is a log of Session API, the use information extraction unit 313 determines “YES” in step 1430, and the processing proceeds to step 1435.

In step 1435, the use information extraction unit 313 reflects the Serial ID and the Tool ID in the use aggregation table 700. A name [SW use aggregation_yyyymmdd] is assigned to the use aggregation table 700. In the name “yyyymmdd”, the date on which the aggregation is performed is substituted.

In step 1440, the use information extraction unit 313 determines whether all Tool IDs in the tool ID management table 500 (Tool ID correspondence table) are confirmed (selected) for the log file selected in step 1410.

If not all the Tool IDs in the tool ID management table 500 (Tool ID correspondence table) are confirmed (selected), the use information extraction unit 313 returns to step 1420 and selects one unselected Tool ID from the Tool ID management table 500 (Tool ID correspondence table), and the processing proceeds to step 1425.

If all the Tool IDs in the tool ID management table 500 (Tool ID correspondence table) are confirmed (selected), the use information extraction unit 313 determines “YES” in step 1440, and the processing proceeds to step 1445.

In step 1445, the use information extraction unit 313 determines whether all the log files (the API logs 138) retrieved in step 1405 are confirmed (selected). If not all the log files are confirmed (selected), the use information extraction unit 313 determines “NO” in step 1445, returns to step 1410, and selects an unselected log file, and the processing proceeds to step 1415.

If all the log files are confirmed (selected), the use information extraction unit 313 determines “YES” in step 1445 and executes the processing of step 1450 to be described later, and then the processing proceeds to step 1495 to temporarily end the present processing flow.

Step 1450: The use information extraction unit 313 reflects contents of the use aggregation table 700 in the use statistical table 800. A name [SW use statistical_yyyymmdd] is assigned to the use statistical table 800. In the name “yyyymmdd”, the date on which the statistics is performed is substituted.

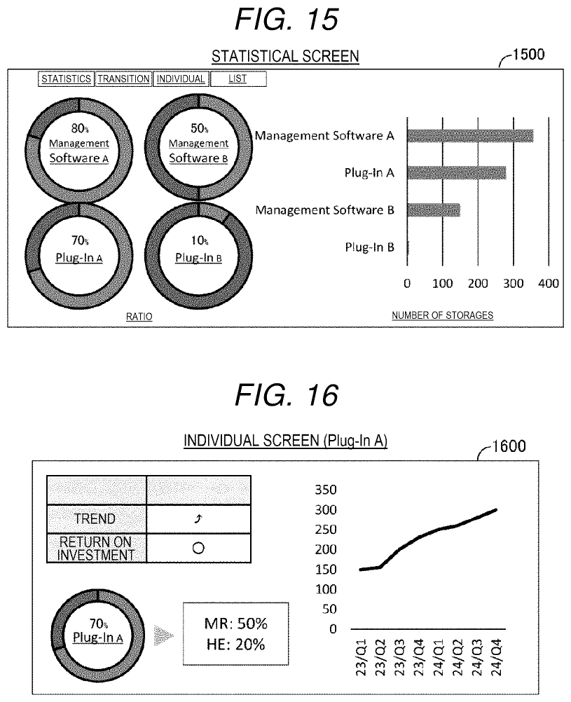

FIG. 15 illustrates an example of a screen created by the use rate display unit 314. An example of the screen illustrated in FIG. 15 is a statistical screen 1500. The statistical screen 1500 illustrates the use situation of each piece of software of the storage system 130.

The statistical screen 1500 includes four pie charts and a line chart. The four pie charts indicate the respective software use rates of Management Software A, Management Software B, Plug-In A, and Plug-In B. The software use rate is a ratio (percentage) of “the number of storage systems using that software” to “the total number of storage systems to be investigated”. The line chart indicates the number of storage systems using the software for each piece of software.

A terminal (not illustrated) of the decision maker 410 can access a Web page of the cloud server 310 with a browser and display a Web page (the statistical screen 1500 in FIG. 15) on a display of the terminal (not illustrated) (the same applies to screens in FIGS. 16 to 19 to be described later). By confirming the statistical screen 1500 of FIG. 5, the decision maker 410 determines which software has a high use rate, which helps to perform a hearing focusing on unused software (functions), to remove functions, or to perform data-driven decision making for additional investment (hereinafter, the same applies to the screens of FIGS. 15 to 19).

FIG. 16 illustrates an example of the screen created by the use rate display unit 314. An example of the screen illustrated in FIG. 16 is an individual screen 1600. The individual screen 1600 illustrates details of a use situation of specific software (selected software). In the present example, details of a use situation of Plug-In A will be described.

The individual screen 1600 includes a table, a pie chart, a frame, and a line graph. The table indicates a result of analyzing a software use rate of specific software (in the present example, Plug-In A). The table indicates a trend and a return on investment related to specific software. The pie chart indicates the software use rate of a specific software. The frame indicates an occupancy rate of a midrange model (MR) and an occupancy rate of a high end model (HE) related to specific software in the frame. The occupancy rate of the MR indicates an occupancy rate (percentage) of the storage system 130 of the MR with respect to the total number of storages using the software. The occupancy rate of the HE indicates an occupancy rate (percentage) of the storage system 130 of the HE with respect to the total number of storages using the software. The line graph is a line graph in which an item on a horizontal axis indicates quarters and an item on a vertical axis indicates the number of storages. A line in the line graph indicates a transition in the number of storages using a specific software for each quarter.

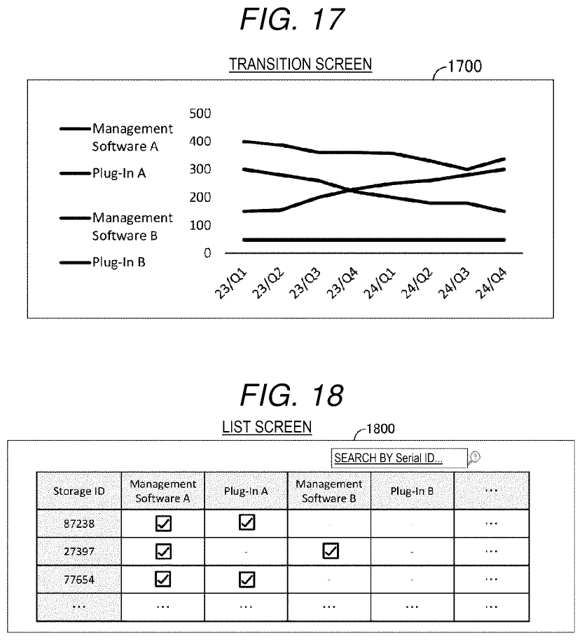

FIG. 17 illustrates an example of the screen created by the use rate display unit 314. An example of the screen illustrated in FIG. 17 is a transition screen 1700. The transition screen 1700 illustrates a transition of the use situation of each piece of software for each quarter. The transition screen 1700 includes a line graph. The line graph is a line graph in which an item on a horizontal axis indicates quarters and an item on a vertical axis indicates the number of storages. Each line in the line graph indicates a transition in the number of storages in which each piece of software is used for each quarter.

FIG. 18 illustrates an example of the screen created by the use rate display unit 314. An example of the screen illustrated in FIG. 18 is a list screen 1800. The list screen 1800 includes a table illustrating the use situation of each piece of software of each storage system 130. The table displays a confirm box with a confirm point indicating that each piece of software is in use in a field corresponding to a software name in the same row as the storage ID. Accordingly, the table indicates whether the software of the storage system 130 indicated by the storage ID is used in an investigation target period (in the present example, one day on a specific date).

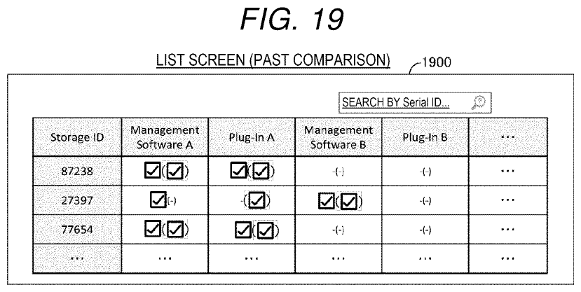

FIG. 19 illustrates an example of the screen created by the use rate display unit 314. An example of the screen illustrated in FIG. 19 is a list screen (past comparison) 1900. The list screen (past comparison) 1900 includes a table indicating a use situation of each piece of software on a specific date of each storage system 130 and a use situation of each piece of software 30 days before the specific date of each piece of software. The table displays a confirm box with a confirm point indicating that each piece of software is in use in a field corresponding to a software name in the same row as the storage ID. A confirm box with a confirm point indicating each piece of software is in use 30 days ago is further displayed in a field corresponding to a software name in the same row as the storage ID. Accordingly, the table indicates the presence or absence of the use of the software in an investigation target period (in the present example, one day on a specific date) and the presence or absence of the use of the software 30 days before the specific date. Based on the table, the user can confirm whether the software has started to be used recently.

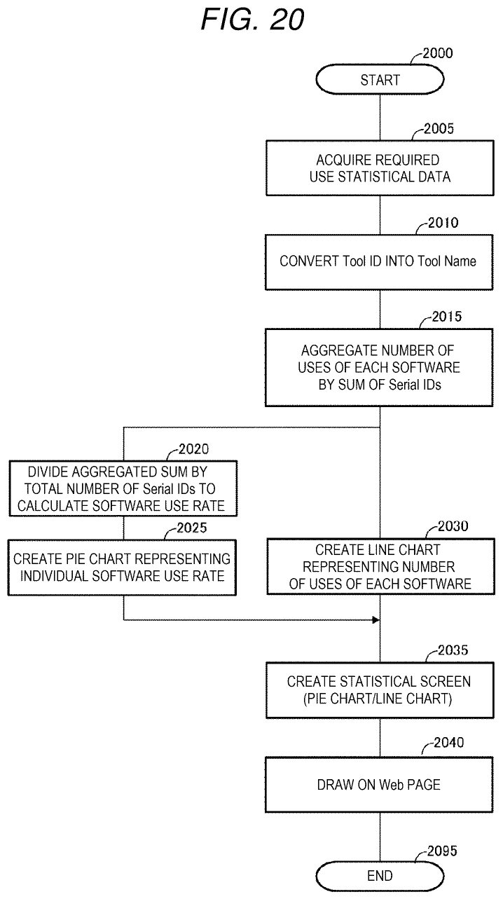

FIG. 20 is a diagram illustrating a processing flow executed by the use rate display unit 314. The present processing flow is a processing flow when drawing the statistical screen 1500 in FIG. 15 on a Web page. The use rate display unit 314 starts processing from step 2000, and sequentially executes processing of step 2005 to step 2015 to be described later.

Step 2005: The use rate display unit 314 acquires statistical data (the use statistical table 800 in FIG. 8A) necessary for creating the statistical screen 1500 in FIG. 15.

Step 2010: The use rate display unit 314 refers to the tool ID management table 500 and converts the Tool ID into the Tool Name (software name).

Step 2015: The use rate display unit 314 aggregates the number of uses (the number of used storage systems) of each piece of software by a sum of Serial IDs. Accordingly, the use rate display unit 314 calculates the number of uses of each piece of software for each storage system 130.

Thereafter, the use rate display unit 314 executes step 2020, step 2025, and step 2030 to be described later in parallel, and then proceeds to step 2035.

Step 2020: The use rate display unit 314 divides the aggregated sum by the total number of Serial IDs to calculate the software use rate.

Step 2025: The use rate display unit 314 creates a pie chart representing an individual software use rate, and then proceeds to step 2035.

Step 2030: The use rate display unit 314 creates a line graph representing transition in use of all software, and then proceeds to step 2035.

In step 2035, the use rate display unit 314 creates the statistical screen 1500. Next, in step 2040, the use rate display unit 314 draws the statistical screen 1500 on the Web page, and then proceeds to step 2095 to temporarily end the present processing flow.

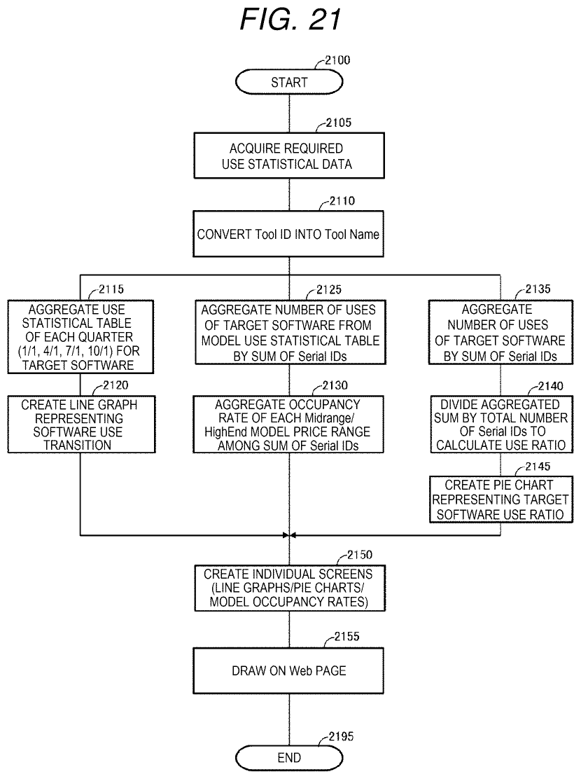

FIG. 21 is a diagram illustrating a processing flow executed by the use rate display unit 314. The present processing flow is a processing flow when drawing the individual screen 1600 in FIG. 16 on a Web page. The use rate display unit 314 starts processing from step 2100, and sequentially executes processing of step 2105 and step 2010 to be described later.

Step 2105: The use rate display unit 314 acquires statistical data (the use statistical table 800 in FIG. 8A) necessary for creating the individual screen 1600 in FIG. 16.

Step 2110: The use rate display unit 314 refers to the tool ID management table 500 and converts the Tool ID into the Tool Name (software name).

The use rate display unit 314 executes step 2115 and step 2120, step 2125 and step 2130, and step 2135 to step 2145 to be described later in parallel, and then proceeds to step 2150.

Step 2115: The use rate display unit 314 aggregates the use statistical table 800 of each quarter for the target software.

Step 2120: The use rate display unit 314 creates a line graph representing a use transition (transition in the number of used storage systems) in the target software.

Step 2125: The use rate display unit 314 aggregates the number of uses of the target software from the model use statistical table 810 of FIG. 8B by the sum of the Serial IDs.

Step 2130: The use rate display unit 314 aggregates an occupancy rate of each Midrange model price range (=sum of Serial IDs of the price range of the Midrange model/sum of Serial IDs) and an occupancy rate of the HighEnd model price range (=sum of Serial IDs of the price range of the HighEnd model/sum of Serial IDs) among the sum of Serial IDs.

Step 2135: The use rate display unit 314 aggregates the number of uses of the target software by the sum of the Serial IDs.

Step 2140: The use rate display unit 314 divides the aggregated sum by the total number of Serial IDs to calculate a use ratio (percentage).

Step 2145: The use rate display unit 314 creates a pie chart representing the use ratio (percentage) of the target software.

In step 2150, the use rate display unit 314 creates the individual screen 1600 of FIG. 16. The table illustrating the trend and the return on investment related to the target software in the individual screen 1600 is created by analysis processing (not illustrated). Next, in step 2155, the use rate display unit 314 draws the individual screen 1600 on the Web page, and then proceeds to step 2195 to temporarily end the present processing flow.

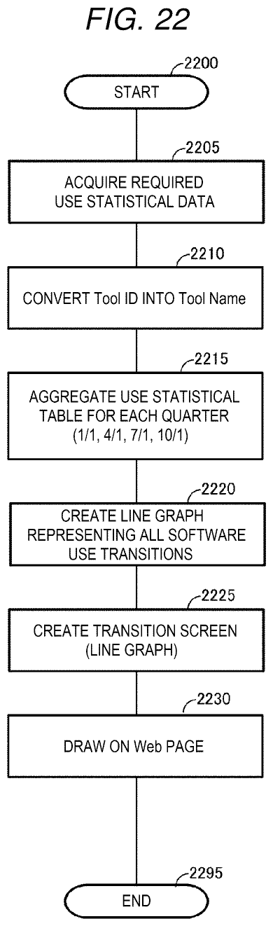

FIG. 22 is a diagram illustrating a processing flow executed by the use rate display unit 314. The present processing flow is a processing flow when drawing the transition screen 1700 of FIG. 17 on a Web page. The use rate display unit 314 starts the processing from step 2200, sequentially executes the processing from step 2205 to step 2230 to be described later, and then proceeds to step 2295 to temporarily end the present processing flow.

Step 2205: The use rate display unit 314 acquires statistical data (use statistical table 800) necessary for creating the transition screen 1700 of FIG. 17.

Step 2210: The use rate display unit 314 refers to the tool ID management table 500 and converts the Tool ID into the Tool Name (software name).

Step 2215: The use rate display unit 314 aggregates the use statistical table 800 of each quarter for all of the target software.

Step 2220: The use rate display unit 314 creates a line graph representing the use transition of each target software. Step 2225: The use rate display unit 314 creates the transition screen 1700 of FIG. 17.

Step 2230: The use rate display unit 314 draws the transition screen 1700 on the Web page.

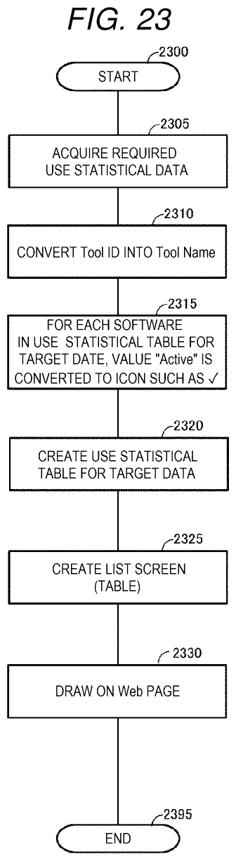

FIG. 23 is a diagram illustrating a processing flow executed by the use rate display unit 314. The present processing flow is a processing flow when drawing the list screen 1800 of FIG. 18 on a Web page. The use rate display unit 314 starts the processing from step 2300, sequentially executes the processing from step 2305 to step 2330 to be described later, and then proceeds to step 2395 to temporarily end the present processing flow.

Step 2305: The use rate display unit 314 acquires statistical data (use statistical table 800) necessary for creating the list screen 1800 of FIG. 18.

Step 2310: The use rate display unit 314 refers to the tool ID management table 500 and converts the Tool ID into the Tool Name (software name).

Step 2315: The use rate display unit 314 converts the value “Active” of each piece of software in the use statistical table 800 on a target day into an icon, such as a confirm box with a confirm point.

Step 2320: The use rate display unit 314 creates the use statistical table 800 on the target day.

Step 2325: The use rate display unit 314 creates the list screen 1800 of FIG. 18.

Step 2330: The use rate display unit 314 draws the list screen 1800 on the Web page.

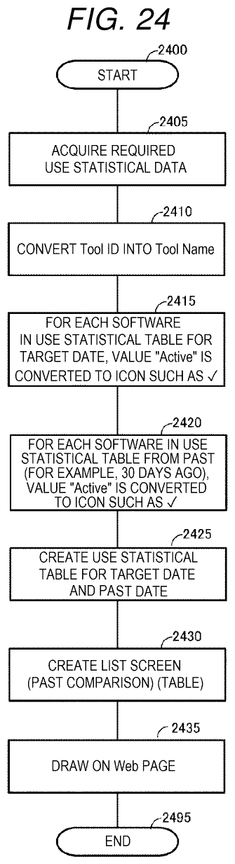

FIG. 24 is a diagram illustrating a processing flow executed by the use rate display unit 314. This processing flow is a processing flow when drawing the list screen (past comparison) 1900 of FIG. 19 on a Web page. The use rate display unit 314 starts the processing from step 2400, sequentially executes the processing from step 2405 to step 2435 to be described later, and then proceeds to step 2495 to temporarily end the present processing flow.

Step 2405: The use rate display unit 314 acquires statistical data (use statistical table 800) necessary for creating the list screen (past comparison) 1900 of FIG. 19.

Step 2410: The use rate display unit 314 converts the Tool ID into Tool Name (software name).

Step 2415: The use rate display unit 314 converts the value “Active” of each piece of software in the use statistical table 800 on a target day into an icon such as a confirm box with a confirm point.

Step 2420: The use rate display unit 314 converts the value “Active” of each piece of software in the use statistical table 800 on the past day (for example, 30 days before) before the target day into an icon, such as a confirm box with a confirm point.

Step 2425: The use rate display unit 314 creates the use statistical table 800 for the latest day and the past day (that is, the table in FIG. 19).

Step 2430: The use rate display unit 314 creates the list screen (past comparison) 1900 of FIG. 19.

Step 2435: The use rate display unit 314 draws the list screen (past comparison) 1900 on the Web page.

### Effects

As described above, the software use situation investigation system according to the first embodiment can grasp the use situation of each piece of software used for the system without requiring a complicated configuration and procedure.

### Second Embodiment

A software use situation investigation system according to a second embodiment of the invention will be described. The invention differs from the software use situation investigation system according to the first embodiment in the following points. The software use situation investigation system according to the second embodiment creates information indicating the use situation of an API used by each piece of software.

Hereinafter, the difference points will be mainly described.

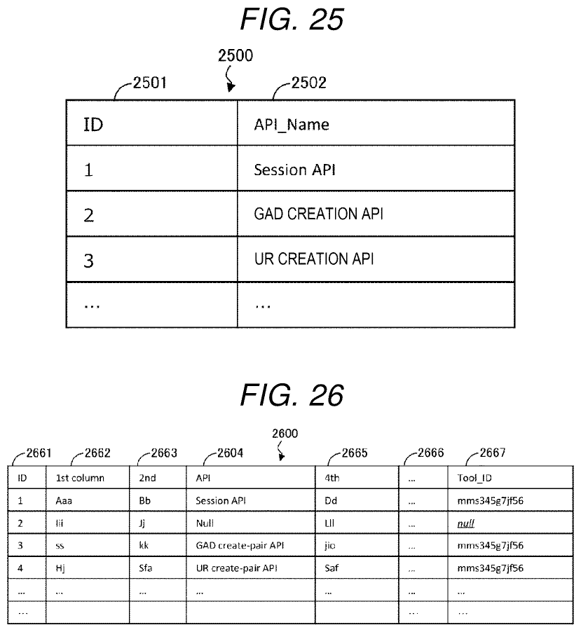

FIG. 25 is a diagram illustrating an API management table 2500 held (stored) by the cloud server 310. As illustrated in FIG. 25, the API management table 2500 includes an ID 2501 and an API Name 2502 as lines (columns) for storing information (values). In the API management table 2500, information corresponding to each line for managing the API is stored as information (records) in units of rows in association with each other.

Specifically, the ID 2501 stores identification information (ID) for identifying the corresponding record. The API Name 2502 stores an API name.

FIG. 26 is a diagram illustrating an example of a log conversion table 2600 held (stored) by the cloud server 310. Each line (column) of the log conversion table 2600 is the same as that in FIG. 6.

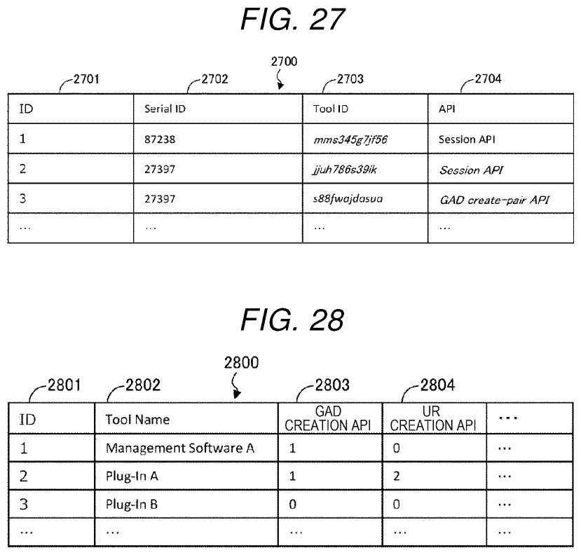

FIG. 27 is a diagram illustrating an API use aggregation table 2700. The API use aggregation table 2700 includes an ID 2701, a Serial ID 2702, a Tool ID 2703, and an API 2704 as lines (columns) for storing information (values). The API use aggregation table 2700 stores information (records) in units of rows corresponding to each line related to aggregation information on the API used for software.

Specifically, the ID 2701 stores identification information (ID) for identifying the corresponding record. The Serial ID 2702 stores identification information (a Serial ID) of the storage system 130. The Tool ID 2703 stores identification information (Tool ID) on the software. The API 2704 stores an API name. As will be described in detail later, the API use aggregation table 2700 is created by the log interpretation unit 312.

FIG. 28 is a diagram illustrating an API use statistical table 2800. The API use statistical table 2800 includes an ID 2801, a Tool Name 2802, a GAD creation API 2803, and a UR creation API 2804 as lines (columns) for storing information (values). In the API use statistical table 2800, information corresponding to each line related to statistical information on the use situation of the API of each piece of software is stored in association with each other as information (record) in units of rows. Specifically, the ID 2801 stores identification information (ID) for identifying the corresponding record. The Tool Name 2802 stores the name of the software. The GAD creation API 2803 stores the number of times a global-active device (GAD) creation API is called by the corresponding software. The UR creation API 2804 stores the number of times the universal replicator (UR) creation API is called by the corresponding software.

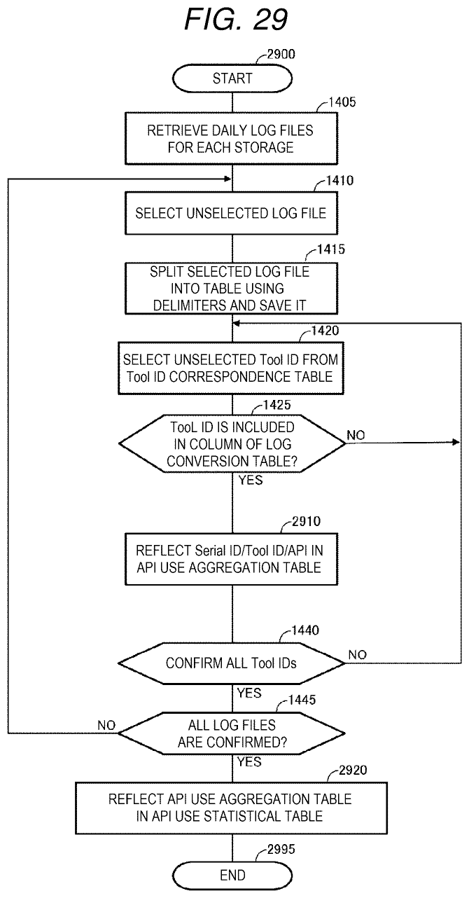

FIG. 29 is a flowchart illustrating a processing flow executed by the log interpretation unit 312 and the use information extraction unit 313. The flowchart of FIG. 29 is the same as the flowchart of FIG. 14 except that the processing of step 1430 is deleted, step 2910 is added between step 1425 and step 1440, and step 2920 is added instead of step 1450 after step 1445 in FIG. 14. Therefore, in the following, differences from the flowchart of FIG. 14 will be mainly described, and other details will be omitted as appropriate.

In step 1425, the use information extraction unit 313 determines whether at least one Tool ID is included in the column of the log conversion table 2600. When no Tool ID is included in the column of the log conversion table 2600, the use information extraction unit 313 determines “NO” in step 1425, returns to step 1420, and executes the above-described processing again.

When at least one Tool ID is included in the column of the log conversion table 2600, the use information extraction unit 313 determines “YES” in step 1425 and proceeds to step 2910. In step 2910, the use information extraction unit 313 reflects the Tool ID, the API type corresponding to the Tool ID in the log conversion table 2600, and the Serial ID corresponding to the API log 138 in the API use aggregation table 2700. Thereafter, the use information extraction unit 313 proceeds to the processing of step 1445.

When all the log files are confirmed in step 1445, the use information extraction unit 313 determines “YES” in step 1445 and proceeds to step 2920. In step 2920, the use information extraction unit 313 reflects the content of the API use aggregation table 2700 in the API use statistical table 2800, proceeds to step 2995, and temporarily ends the present processing flow. By executing the above processing, the API use statistical table 2800 is created from the API log 138.

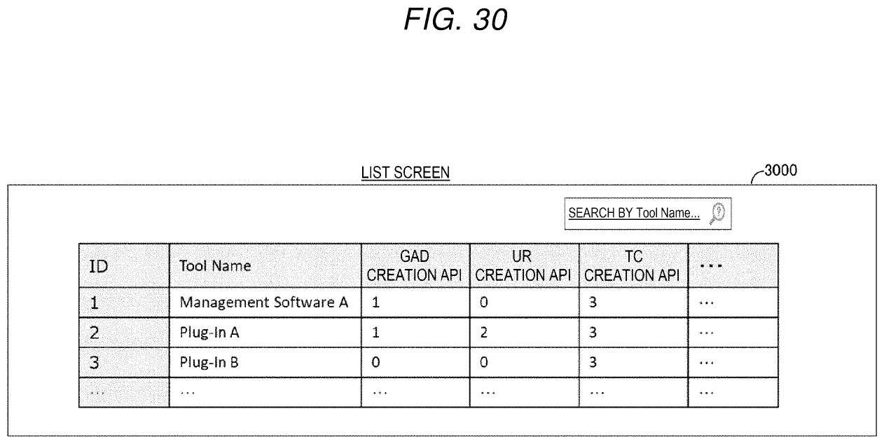

FIG. 30 illustrates an example of the screen created by the use rate display unit 314. An example of the screen illustrated in FIG. 30 is a list screen 3000. The list screen 3000 includes a table indicating the use situation of each API of each piece of software. The list screen 3000 indicates the use number of each API of each piece of software in the table. For example, a record (row) in which the ID of the table is “1” indicates that the use number of the GAD creation API of Management Software A is one, the use number of the UR creation API is zero, and the use number of a true copy (TC) creation API is three.

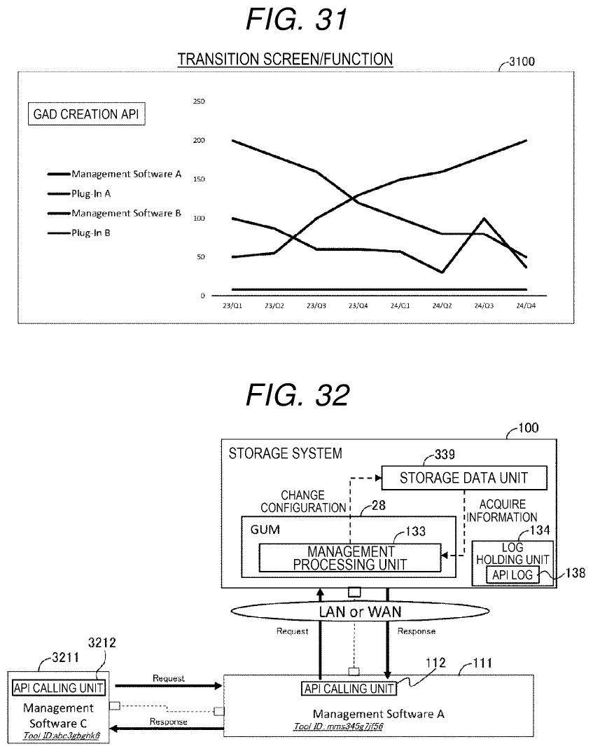

FIG. 31 illustrates an example of the screen created by the use rate display unit 314. An example of the screen illustrated in FIG. 31 is a transition screen/function 3100. The transition screen/function 3100 indicates a transition in the use number of a specific API (in the present example, the GAD creation API) of each piece of software for each quarter. The transition screen/function 3100 includes a line graph. The line graph is a line graph in which an item on a horizontal axis indicates quarters and an item on a vertical axis indicates the use number of the API. Each line in the line graph indicates a transition in the use number of the API by each piece of software for each quarter. By confirming the screens of FIGS. 30 and 31, the decision maker 410 can specify the API that is frequently used, and can lead to an activity of improving customer convenience, such as performing additional development on the API.

### Effects

As described above, similarly to the first embodiment, the software use situation investigation system according to the second embodiment can grasp the use situation of each piece of software used for the system without requiring a complicated configuration and procedure. Similarly to the first embodiment, the software use situation investigation system according to the second embodiment can grasp the use situation of the API provided by the storage system 130 used by the software without requiring a complicated configuration and procedure.

### Modifications

The invention is not limited to the embodiments described above, and various modifications can be adopted within the scope of the invention. Further, the embodiments described above can be combined with one another without departing from the scope of the invention.

In each embodiment of the invention, as illustrated in FIG. 32, when receiving a Tool ID in response to a request from a high-level management software 3211, the API calling unit 112 may embed the Tool ID of the high-level management software 3211 in the API request to the management processing unit 133 of the storage system 130 instead of the Tool ID of its own management software 111. In this case, the API calling unit 112 may embed the Tool ID of the high-level management software 3211 and the Tool ID of its own software in the API request.

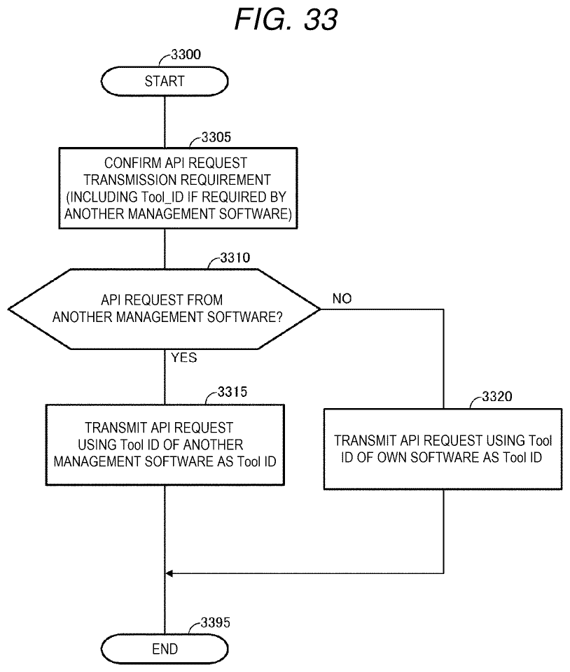

FIG. 33 illustrates a processing flow executed by the API calling unit 112 of this modification. The API calling unit 112 starts processing from step 3300, proceeds to step 3305, and confirms a transmission requirement of the API request. At this time, if the requirement is from another management software 3211, a Tool ID of another management software 3211 is held.

Thereafter, the API calling unit 112 proceeds to step 3310 and determines whether the API request to be transmitted is an API request from another management software 3211.

If the API request to be transmitted is an API request from another management software 3211, the API calling unit 112 determines “YES” in step 3310 and proceeds to step 3315. In step 3315, the API calling unit 112 transmits the API request to the management processing unit 133 of the storage system 130 using the Tool ID of another management software as the Tool ID instead of its own Tool ID. Thereafter, the API calling unit 112 proceeds to step 3395 and temporarily ends the present processing flow.

On another hand, if the API request to be transmitted is not an API request from another management software 3211, the API calling unit 112 determines “NO” in step 3310 and proceeds to step 3330.

In step 3320, the API calling unit 112 transmits the API request to the management processing unit 133 of the storage system 130 using its own Tool ID as a Tool ID. Thereafter, the API calling unit 112 proceeds to step 3395 and ends the present processing flow.

According to this modification, when another management software 111 is interposed between the management software 3211 and the storage system 130, when the management software 111 itself has an API, the API calling unit 112 receives a call from another management software 3211 through the API, and issues the API to the storage system (the management processing unit 133) again. In this case, the API calling unit 112 of the management software 111 describes a Tool ID of a caller and transmits the API request to the management processing unit 133 such that the management software 3211 of the API caller can recognize the API request. Accordingly, in the storage system 130, since the Tool ID of the API caller of the management software 3211 is recorded in the API log 138, the API caller can be specified even when another management software 111 is interposed between the management software 3211 and the storage system 130.

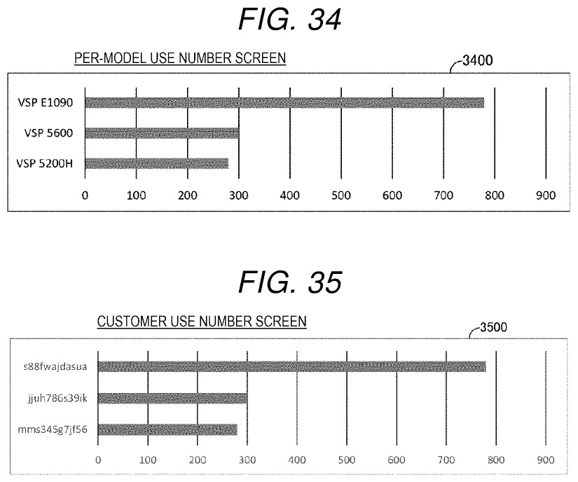

In the embodiments described above, the use information extraction unit 313 may calculate the number of pieces of software used for each model based on the model use statistical table 810, and store the calculated number of pieces of software used for each model in the database 316 as statistical information. In this case, the use rate display unit 314 may create and display a per-model use number screen 3400 illustrated in FIG. 34 based on the statistical information. The per-model use number screen 3400 indicates the number of pieces of software used for each model. According to this modification, the decision maker 410 can specify software having a high use rate in each of a mid-range band and a high-end band on the per-model use number screen 3400. Accordingly, the decision maker 410 can preferentially develop a function suitable for the user, even in the function development of the management software.

In the embodiments described above, the use information extraction unit 313 may calculate the number of customers using each piece of software based on the customer use statistical table 820, and store the calculated number of customers of each piece of software in the database 316 as statistical information. In this case, the use rate display unit 314 may create and display a customer use number screen 3500 illustrated in FIG. 35 based on the statistical information. The customer use number screen 3500 indicates the number of customers using each piece of software. According to this modification, the decision maker 410 can utilize the statistical information for the customer segment analysis of the management software on the customer use number screen 3500, and can improve the product value.

In the embodiments described above, it is assumed that the API log 138 is output for each API request, and the type of API is written. In contrast, in a first modification, an API request path included in the API request and a log JSON file included in the request may be further written to the API log 138. In this case, for the type of the API, the type of the API may be extracted by designating a specific keyword.

The invention may be applied to systems other than the storage system 130. Examples of another system include a settlement system that provides an API and a content management system that provides an API. The invention can also adopt the following configurations.

A software use situation investigation system includes:
a system configured to provide an API and including an arithmetic device and a storage device;
a management server into which software is introduced, the management server configured to transmit an API request to the system and receive an API response from the system by an operation of the software; and
a software use situation investigation apparatus including an information processing apparatus, in which
the management server includes identification information on the software in the API request and transmits the API request to the system,
the arithmetic device of the system stores, in the storage device, an API log in which a record of API access to an API provided by the system by the software is written such that the identification information on the software remains, and
the information processing apparatus acquires the API log from the system and generates information indicating a use situation of the software from the API log.

What is claimed is:

1. A software use situation investigation system comprising:
a plurality of systems each configured to provide an API and each including an arithmetic device and a first storage device;
a plurality of client servers into which software that accesses the API via a network and executes a function is introduced, the client servers each configured to transmit an API request to the system and receive an API response from the system by an operation of the software; and
a software use situation investigation apparatus including an information processing apparatus, wherein
the client server includes identification information on the software in the API request and transmits the API request to the system,
the arithmetic device of the system records an API log that is a log related to API access to the API by the software such that the identification information on the software is included in the API log, and stores the API log in the first storage device, and
the information processing apparatus acquires the API log from the system and creates information indicating a use situation of the software based on the API log.

2. The software use situation investigation system according to claim 1, wherein
the information processing apparatus
includes a second storage device,
stores a plurality of the API logs for each of the systems acquired from the plurality of systems in the second storage device,
acquires the plurality of API logs for each of the systems in an investigation target period from the second storage device, and
creates the information indicating the use situation of the software from the plurality of API logs for each of the systems.

3. The software use situation investigation system according to claim 2, wherein
the information processing apparatus
extracts the identification information on the software from the plurality of API logs, and
creates the information indicating a use situation of the software by using the extracted identification information on the software.

4. The software use situation investigation system according to claim 3, wherein
the API provided by the system includes a session generation API that generates a session, and
the information processing apparatus specifies a log of the API access to the session generation API of the software from the plurality of API logs by using the extracted identification information on the software, and creates the information indicating a use situation of the software based on the specified log of the API access.

5. The software use situation investigation system according to claim 4, wherein
the information processing apparatus creates information indicating presence or absence of use of the software for each of the systems as the information indicating the use situation of the software based on the specified log of the API access.

6. The software use situation investigation system according to claim 5, wherein
the information processing apparatus divides the API log with a delimiter to extract the identification information on the software and an API type from the API log, creates correspondence information in which the extracted identification information on the software and the extracted API type are associated with each other, and specifies the log of the API access to the session generation API of the software in the API log by using the identification information on the software and the correspondence information.

7. The software use situation investigation system according to claim 1, wherein
the information processing apparatus divides the API log with a delimiter to extract the identification information on the software and an API type from the API log, creates correspondence information in which the extracted identification information on the software and the extracted API type are associated with each other, aggregates a number of calls of the API of the software by using the identification information on the software and the correspondence information, and creates information indicating a use situation of the function of the software as the information indicating the use situation of the software based on aggregation information.

8. The software use situation investigation system according to claim 4, wherein
the information processing apparatus creates, as the information indicating the use situation of the software, at least one of a use rate of the software for the plurality of systems, a transition in the use situation of the software, a number of customers using the software, and a use number of the software for each type of the systems.

9. The software use situation investigation system according to claim 1, wherein
the information processing apparatus is connected to a display device, and
the information processing apparatus displays a screen including the information indicating the use situation of the software on the display device.

10. The software use situation investigation system according to claim 1, wherein
when one of the plurality of client servers receives the API request from another client server by an operation of the software of the other client server, the one client server transmits the API request from the other client server to the system and transmits the API response received from the system to the other client server by an operation of the software of the one client server, and
the one client server includes, in the API request to be transmitted to the system, identification information on the software of the other client server instead of identification information on the software of the one client server, and transmits the API request.

11. The software use situation investigation system according to claim 1, wherein
when one of the plurality of client servers receives the API request from another client server by an operation of the software of the other client server, the one client server transmits the API request from the other client server to the system and transmits the API response received from the system to the other client server by an operation of the software of the one client server, and
the one client server includes, in the API request to be transmitted to the system, identification information on the software of the other client server together with identification information on the software of the one client server, and transmits the API request.

12. The software use situation investigation system according to claim 1, wherein
the system is a storage system.

13. A software use situation investigation apparatus comprising:
an information processing apparatus configured to investigate a use situation of software that accesses an API provided by a system via a network and execute a function of the software, wherein
the information processing apparatus acquires, from the system, an API log that is a log related to API access to the API by the software to which identification information is assigned and is recorded to include the identification information on the software, and creates information indicating the use situation of the software based on the API log.

14. A software use situation investigation method using an information processing apparatus, the information processing apparatus configured to investigate a use situation of software that accesses an API provided by a system via a network and execute a function of the software, the software use situation investigation method comprising:
acquiring, from the system, an API log that is a log related to API access to the API by the software to which identification information is assigned and is recorded to include the identification information on the software, and creating information indicating the use situation of the software based on the API log by the information processing apparatus.
